(19) United States
(12) Patent Application Publication
(10) Pub. No.: US 2006/0149441 A1
(43) Pub. Date: Jul. 6, 2006

(54) Failure detection device and method for oil temperature sensor for automatic transmission

(75) Inventor: Shinichi Takamura, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/297,375

(22) Filed: Dec. 9, 2005

(30) Foreign Application Priority Data
Dec. 21, 2004 (JP) 2004-369819

(51) Int. Cl. G01M 17/00

(52) U.S. Cl. 701/34; 701/62

(57) ABSTRACT

A failure detection device and method for an oil temperature sensor that detects an oil temperature of hydraulic fluid of an automatic transmission mounted in a vehicle. It is determined that a failure has occurred in the oil temperature sensor if the oil temperature, which is detected by the oil temperature sensor when a predetermined elapsed-time has elapsed since an engine of the vehicle is started, is not within a predetermined temperature range. The predetermined elapsed-time is variably set based on the oil temperature that is obtained when the engine of the vehicle is started.

### INCORPORATION BY REFERENCE

The disclosure of Japanese Patent Application No. 2004-369819 filed on Dec. 21, 2004 including the specification, drawings and abstract is incorporated herein by reference in its entirety.

### BACKGROUND OF THE INVENTION

1. Field of the Invention.

The invention relates generally to a failure detection device and method for an oil temperature sensor for an automatic transmission, and, more specifically, to such failure detection device and method which can frequently determine whether a failure has occurred in the oil temperature sensor.

2. Description of the Related Art

An automatic transmission for a vehicle, which is formed by combining a torque converter including a pump, a turbine, a stator, etc. with a multistage gear type shift mechanism connected to the turbine of the torque converter, is widely used. Such an automatic transmission is usually provided with a hydraulic control unit mainly including a hydraulic circuit portion. The hydraulic control unit is configured to apply/release hydraulically-driven friction engaging elements such as a clutch and a brake in the shift mechanism. Thus, the shift speed of the automatic transmission is changed.

In the automatic transmission provided with such a hydraulic control unit, when the shift speed is changed, hydraulic pressure to be supplied to the friction engaging element is formed in the hydraulic circuit portion that applies the friction engaging element. At this time, the valve-open-time and the opening amount of a hydraulically-controlled valve included in the hydraulic circuit portion are changed based on, for example, a pulse duty factor of a drive pulse signal to be supplied from a control unit to the hydraulically-controlled valve. As a result, the hydraulic pressure is controlled.

When the shift speed of the automatic transmission is changed, the hydraulic pressure to be supplied to the friction engaging element is changed based on the predetermined characteristics. In such a case, the viscosity of the hydraulic fluid is higher and, therefore, the response to the shift operation is lower when the temperature of the hydraulic fluid (hereinafter, sometimes referred to as the “oil temperature”) is low, than when the oil temperature is high. To address such a problem, the automatic transmission is usually provided with an oil temperature sensor that detects the temperature of the hydraulic fluid. The hydraulic pressure control unit supplies hydraulic fluid to the friction engaging element based on the oil temperature detected by the oil temperature sensor.

In such an automatic transmission, a failure in the oil temperature sensor interferes with the shift control. Accordingly, a failure in the oil temperature sensor needs to be accurately detected.

Also, in the control unit of the automatic transmission, the response to the control is reduced, when the temperature of the hydraulic fluid is low. As a result, the drivability deteriorates. To prevent such a problem, a regulation is made in the U.S. According to the regulation, the control for prohibiting the shift control must be performed until the temperature of the hydraulic fluid reaches the predetermined threshold value. Accordingly, in this control as well, a failure in the oil temperature sensor must be accurately detected.

A known failure detection device for an oil temperature sensor for an automatic transmission is disclosed in, for example, Japanese Patent Application Publication No. JP-A-09-329222. This failure detection device includes vehicle speed detecting means; oil temperature detecting means for detecting the temperature of hydraulic fluid; and failure determining means for determining whether a failure has occurred in the oil temperature sensor based on the results of detection performed by these detecting means.

According to the technology disclosed in the above publication, the failure determining means determines whether a failure has occurred in the oil temperature detecting means based on the signals detected by the vehicle speed detecting means and the oil temperature detecting means. The failure determining means determines that a failure has occurred in the oil temperature detecting means, if the amount of increase in the oil temperature is equal to or lower than the predetermined value. In this case, the amount of increase corresponds to the difference between the oil temperature that is detected when the vehicle started running, and the oil temperature that is detected after the vehicle has run in the manner in which the vehicle first runs at a speed equal to or higher than the first predetermined vehicle speed for the first predetermined time or longer, and then runs at a speed equal to or higher than the second predetermined vehicle speed for the second predetermined time or longer.

However, the failure detection device for an oil temperature sensor disclosed in Japanese Patent Application Publication No. JP-A-09-329222 has the following problem. This failure detection device always determines whether a failure has occurred in the oil temperature sensor (hereinafter, sometimes referred to as “makes a failure determination”) at or after the time at which the predetermined set time, corresponding to the sum of the first predetermined time and the second predetermined time, has elapsed since the vehicle started running. With this failure detection device, because whether a failure has occurred in the oil temperature sensor is determined after the temperature of all the oil in the automatic transmission becomes uniform, the failure determination can be accurately made. However, it takes considerably long until a failure determination is started. As a result, if the time that has elapsed since the engine is started (hereinafter, simply referred to as the “elapsed-time”) is shorter than the predetermined set time, whether a failure has occurred in the oil temperature sensor is not determined, raising a problem that the failure determination cannot be made sufficiently frequently.

### SUMMARY OF THE INVENTION

It is, therefore, an object of the invention to provide a failure detection device for an oil temperature sensor for an automatic transmission, which can frequently determine whether a failure has occurred in the oil temperature sensor.

According to an aspect of the invention, there is provided a failure detection device for an oil temperature sensor that detects the temperature of hydraulic fluid of an automatic transmission mounted in a vehicle. The failure detection device includes a determining device that determines that a failure has occurred in the oil temperature sensor if the oil temperature, which is detected by the oil temperature sensor when a predetermined time (hereinafter, referred to as a “predetermined elapsed time”) has elapsed since the engine of the vehicle is started, is not within a predetermined temperature range. The determining device variably sets the predetermined elapsed-time based on the oil temperature that is obtained when an engine of the vehicle is started.

According to another aspect of the invention, there is provided a failure detection method for an oil temperature sensor that detects the temperature of hydraulic fluid of an automatic transmission mounted in a vehicle. According to this failure detection method, it is determined that a failure has occurred in the oil temperature sensor, if the oil temperature, which is detected by the oil temperature sensor when the predetermined elapsed-time has elapsed since the engine of the vehicle is started, is not within a predetermined temperature range. The predetermined elapsed-time is variably set based on the oil temperature that is obtained when an engine of the vehicle is started.

With the above-mentioned failure detection device and method for an oil temperature sensor, the failure determination can be made more frequently.

### BRIEF DESCRIPTION OF THE DRAWINGS

The features, advantages thereof, and technical and industrial significance of this invention will be better understood by reading the following detailed description of the exemplary embodiments of the invention, when considered in connection with the accompanying drawing, in which:

FIG. 1 illustrates the schematic block diagram of a power-train of a vehicle provided with a failure detection device for an oil temperature sensor for an automatic transmission (hereafter, sometimes referred to as an A/T oil temperature sensor) according to an embodiment of the invention;

FIG. 2 illustrates the graph showing the relationship between the oil temperature TO detected by an A/T oil temperature sensor 310 that is operating normally, and the elapsed-time “t” that has elapsed since the engine is started;

FIG. 3 illustrates the flowchart for describing the failure detection operation performed by a failure detection device for an A/T oil temperature sensor in the related art;

FIG. 4 illustrates the table showing the detailed determination conditions used in the flowchart in FIG. 3;

FIG. 5 illustrates the graph showing the relationship between the oil temperature TO detected by an A/T oil temperature sensor 310 and the elapsed-time “t”, which is used in the embodiment of the invention;

FIG. 6 illustrates the flowchart for describing the failure detection operation performed by a failure detection device for an A/T oil temperature sensor according to the embodiment of the invention; and

FIG. 7 illustrates the table showing the detailed determination conditions used in the flowchart in FIG. 6.

### DETAILED DESCRIPTION OF THE EXEMPLE EMBODIMENTS

In the following description and the accompanying drawings, the present invention will be described in more detail with reference to exemplary embodiments, and the same or corresponding portions are denoted by the same reference numerals.

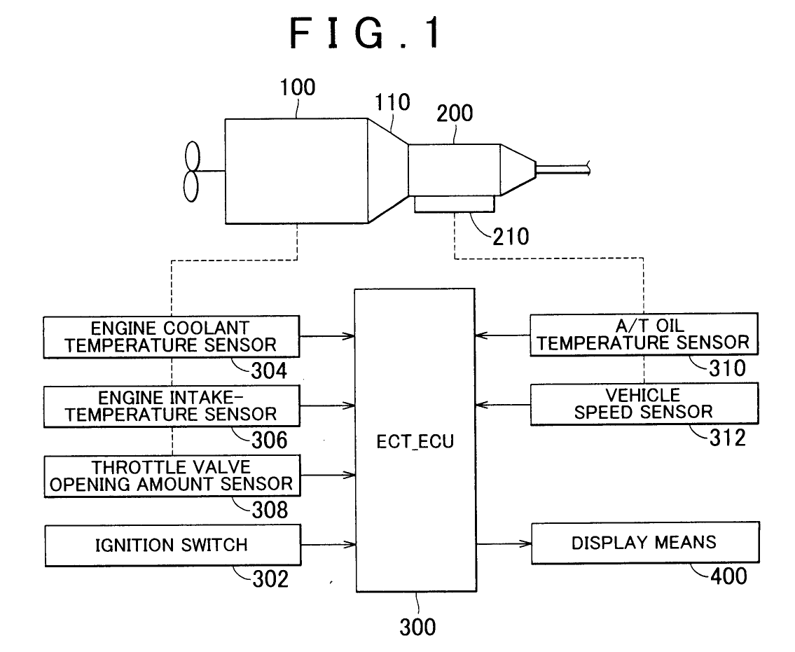

FIG. 1 illustrates the schematic block diagram of a power-train of a vehicle provided with a failure detection device for an oil temperature sensor for an automatic transmission according to an embodiment of the invention.

As shown in FIG. 1, the power-train of the vehicle includes an engine 100; a torque converter 110; an automatic transmission 200; a control valve 210; and an ECT_ECU (Electronic Controlled Automatic Transmission_Electronic Control Unit) 300.

The output shaft of the engine 100 is connected to the input shaft of the torque converter 110. The engine 100 is connected to the torque converter 110 via the rotating shaft.

Further, the torque converter 110 is connected to the automatic transmission 200 via the rotating shaft.

The automatic transmission 200 includes a plurality of friction elements such as a clutch and a brake. In the automatic transmission 200, a hydraulic circuit is controlled such that the clutch and the brake are applied/released based on the requested shift speed, according to the predetermined operation chart.

The ECT_ECU 300 constitutes a control unit of the automatic transmission 200. The ECT_ECU 300 includes memory (not shown) that stores programs and various data; and a CPU (Central Processing Unit) (not shown) that performs the programs stored in the memory. The ECT_ECU 300, along with an engine ECU (not shown) that is a control unit of the engine 100, is included in an ECU (not shown).

As shown in FIG. 1, the ECT_ECU 300 is connected to the input signal lines from an ignition switch 302, an engine coolant temperature sensor 304, an engine intake-temperature sensor 306, and a throttle valve opening amount sensor 308, through which signals are input in the ECT_ECU 300. In addition, the output signal lines from the ECT_ECU 300 are connected to an A/T ON/OFF solenoid (not shown) and an A/T linear solenoid (not shown) provided in the control valve 210.

The engine coolant temperature sensor 304 detects the coolant temperature TW of the coolant for the engine 100. The engine intake-temperature sensor 306 detects the intake-temperature TA of the air taken into the engine 100. The throttle valve opening amount sensor 308 detects the opening amount of the throttle valve (not shown) that controls the amount of air taken into the engine 100.

An A/T oil temperature sensor 310 is provided in the control valve 210, and detects the oil temperature TO of the hydraulic fluid of the automatic transmission 200. A vehicle speed sensor 312 detects the vehicle speed based on the rotational speed of the drive shaft coupled with the output shaft of the automatic transmission 300.

The ECT_ECU 300 detects that the engine 100 is started, based on the signal from the ignition switch 302. When receiving the signals indicative of the results of detection performed by the engine coolant temperature sensor 304, the engine intake-temperature sensor 306, the throttle valve opening amount sensor 308, the A/T oil temperature sensor 310 and the vehicle speed sensor 312, and the signal indicative of the position of the shift lever selected by driver from a shift position sensor (not shown), the ECT_ECU 300 performs arithmetic processing to calculate a solenoid control signal based on the results of detection performed by these sensors and the programs and maps stored in the memory. The A/T linear solenoid and the A/T ON/OFF solenoid of the automatic transmission are controlled based on the solenoid control signal, and the friction engaging elements are applied/released such that the predetermined shift speed is achieved.

In the embodiment, the ECT_ECU 300 constitutes a failure detection device for an A/T oil temperature sensor that determines whether a failure has occurred in the A/T oil temperature sensor 310. Hereafter, the operation for determining whether a failure has occurred in the A/T oil temperature sensor 310, which is performed by the ECT_ECU 300, will be described in detail.

First, the failure detection method for an A/T oil temperature sensor, which is commonly employed in the related art, and the problems of this detection method will be described in detail. Next, the failure detection method for an A/T oil temperature sensor according to the invention will be described in detail, in comparison with the failure detection method for an A/T oil temperature sensor in the related art. In the failure detection method for an A/T oil temperature sensor in the related art, the power-train of the vehicle has the same structure as shown in FIG. 1, and the ECT_ECU 300 that controls the automatic transmission constitutes the failure detection device for an A/T oil temperature sensor.

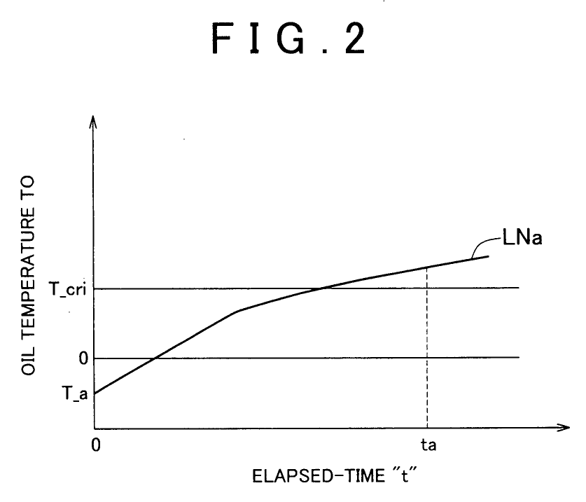

Hereafter, the failure detection method for an A/T oil temperature sensor in the related art will be described in detail. FIG. 2 illustrates the graph showing the relationship between the oil temperature TO detected by the A/T oil temperature sensor 310 that is operating normally and the elapsed-time “t” that has elapsed since the engine 100 is started.

As shown in FIG. 2, the oil temperature TO (=T_a) that is detected when the elapsed-time “t” is “0” (“t”=“0”) indicates the oil temperature that is detected by the A/T oil temperature sensor 310 when starting of the engine 100 is initiated by setting the ignition switch 302 to the engine start position (hereinafter, this oil temperature TO will be sometimes referred to as the initial oil temperature TO_int). As indicated by the solid line LNa in FIG. 2, the oil temperature TO gradually increases as the elapsed-time “t” increases. When the elapsed-time “t” exceeds the predetermined time “ta”, the oil temperature TO becomes higher than the predetermined threshold value T_cri.

At this time, because the oil temperature TO exceeds the predetermined threshold value T_cri, the ECT_ECU 300 becomes able to operate normally, and starts controlling the shift operation of the automatic transmission 200. Hereafter, the oil temperature T_cri at which the ECT_ECU 300 starts the control will be sometimes referred to as the control start oil temperature.

In the automatic transmission 200, if the oil temperature TO is equal to or lower than the control start oil temperature T_cri, the normal shift control by the ECT_ECU 300 is not ensured. Accordingly, the control signal output from the ECT_ECU 300 is masked and disabled. When the oil temperature TO exceeds the control start oil temperature T_cri, the control signal is unmasked and enabled. Therefore, the A/T oil temperature sensor 310 needs to accurately determine whether the oil temperature TO has reached the control start oil temperature T_cri.

Therefore, in the failure detection method for the A/T oil temperature sensor in the related art, the ECT_ECU 300 determines whether a failure has occurred in the A/T oil temperature sensor, using the control start oil temperature T_cri as the criterion for the determination. More specifically, the ECT_ECU 300 determines that the A/T oil temperature sensor 310 is operating normally, if the oil temperature TO, which is detected by the A/T oil temperature sensor 310 when the elapsed-time “t” reaches the predetermined time “ta”, is within the predetermined temperature range including the control start oil temperature T_cri. On the other hand, the ECT_ECU 300 determines that a failure has occurred in the A/T oil temperature sensor 310, if the oil temperature TO, which is detected by the A/T oil temperature sensor 310 when the elapsed-time “t” reaches the predetermined time “ta”, is not within the predetermined temperature range.

The predetermined temperature range is set to a temperature range of the oil temperature TO in which the normal shift operation of the automatic transmission is ensured. The lower limit of the predetermined temperature range is the control start oil temperature T_cri, and the upper limit thereof is the maximum value of the oil temperature TO at which the normal operation of the ECT_ECU 300 is ensured (hereinafter, this maximum value will be sometimes referred to as the “control ensured oil temperature T_max”). Namely, it is determined that the A/T oil temperature sensor 310 is operating normally, if the oil temperature TO, which is detected when the elapsed-time “t” reaches the predetermined time “ta”, is equal to or higher than the control start oil temperature T_cri and lower than the control ensured oil temperature T_max. On the other hand, it is determined that a failure has occurred in the A/T oil temperature sensor 310, if the oil temperature TO, which is detected when the elapsed-time “t” reaches the predetermined time “ta”, is lower than the control start oil temperature T_cri, or equal to or higher than the control ensured oil temperature T_max.

At the time point at which the predetermined time “ta” has elapsed since the engine 100 is started, whether a failure has occurred in the A/T oil temperature sensor 310 is determined. The predetermined time “ta” corresponds to the elapsed-time “t” that is required for the oil temperature TO to reach the control start oil temperature T_cri. The length of the elapsed-time “t” greatly depends on the initial oil temperature TO_int.

For example, as shown in FIG. 2, when the initial oil temperature TO_int is the predetermined very low temperature that is equal to or lower than “0” degree (TO_int=T_a), the elapsed-time “t” required for the oil temperature TO to reach the control start oil temperature T_cri is considerably long.

Meanwhile, according to the existing regulation in the U.S., the lower limit of the range of the temperature that must be detected by the A/T oil temperature sensor 310 must be the predetermined very low temperature T_a. At a temperature of equal to or higher than the predetermined very low temperature T_a, whether a failure has occurred in the A/T oil temperature sensor 310 should be determined.

Accordingly, the failure detection device for an A/T oil temperature sensor in the related art determines whether a failure has occurred in the A/T oil temperature sensor 310 in the following method. In this method, the predetermined time “ta” is uniformily set to the elapsed-time “t” that is required for the oil temperature TO to reach the control start oil temperature T_cri when the initial oil temperature TO_int is the predetermined very low temperature T_a. Then, it is determined whether a failure has occurred in the A/T oil temperature sensor 310 based on whether the oil temperature TO, which is detected when the predetermined time “ta” has elapsed since the engine 100 is started, is within the above-mentioned predetermined temperature range.

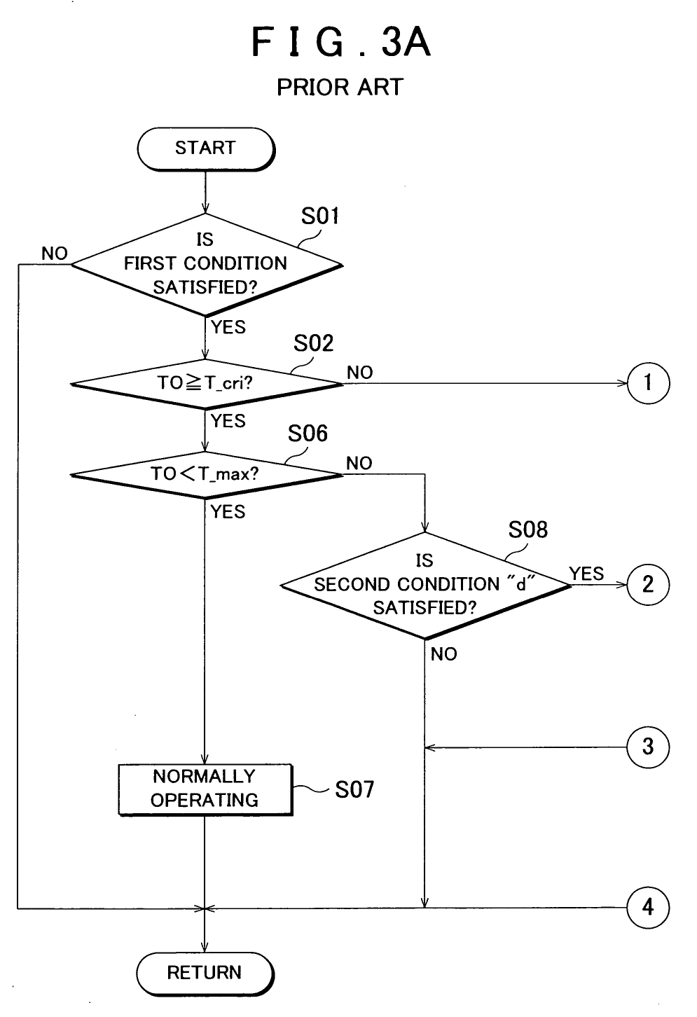

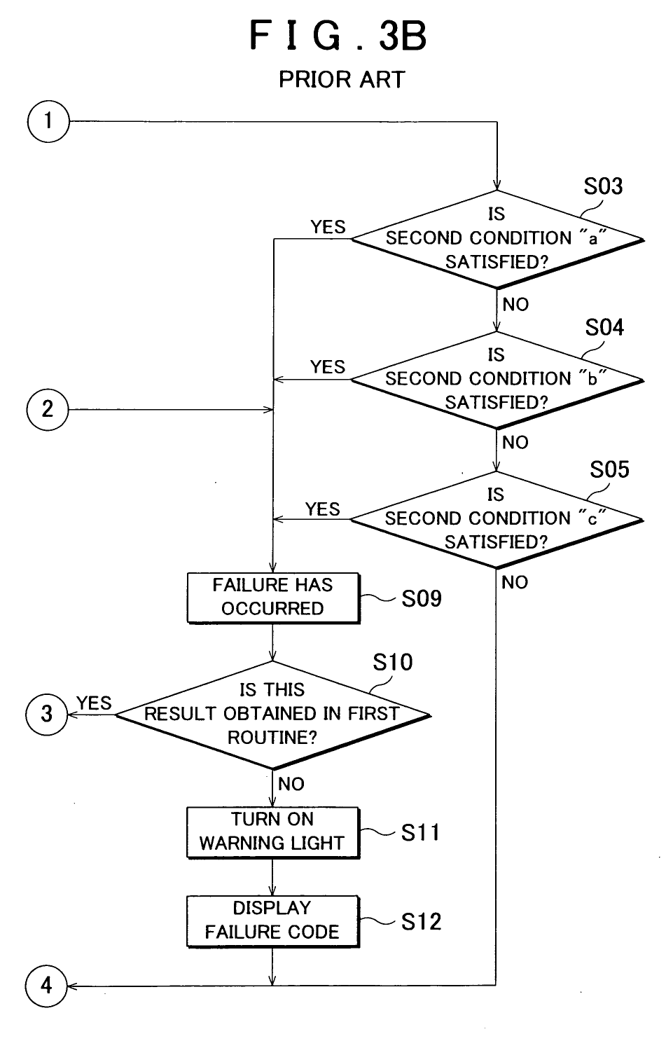

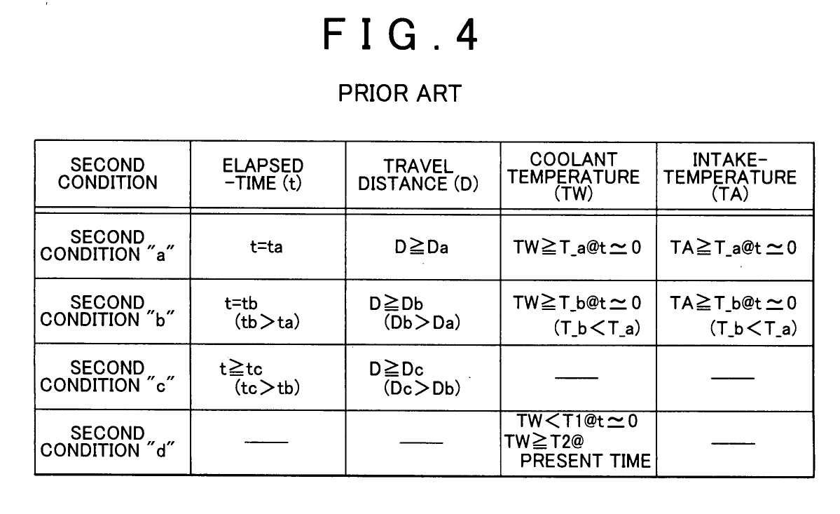

FIG. 3 illustrates the flowchart for describing the failure detection operation performed by the failure detection device for an A/T oil temperature sensor in the related art. FIG. 4 illustrates the detailed determination conditions used in the flowchart in FIG. 3.

The failure detection operation will be described with reference to the flowchart in FIG. 3. The ECT_ECU 300 first determines in step S01 whether the first condition for the failure detection operation is satisfied. When the first condition is satisfied, the following failure detection operation can be performed. The first condition includes the condition that the predetermined elapsed-time “t” has elapsed since the engine 100 is started (since the elapsed-time “t” is “0”). The first condition also includes the condition that no electric failure has occurred in the engine coolant temperature sensor 304, the engine intake-temperature sensor 306, an electronic throttle system (not shown), and the like in FIG. 1.

If it is determined that the first condition is satisfied, the ECT_ECU 300 determines in step S02 whether the oil temperature TO detected at this time by the A/T oil temperature sensor 310 is equal to or higher than the control start oil temperature T_cri.

If it is determined that the oil temperature TO is equal to or higher than the control oil temperature T_cri, the ECT_ECU 300 determines in step S06 whether the oil temperature TO is lower than the control ensured oil temperature T_max. If it is determined that the oil temperature TO is lower than the control ensured oil temperature T_max, namely, if it is determined that the oil temperature TO is within the predetermined temperature range (T_cri≦TO<T_max), the ECT_ECU 300 determines in step S07 that the A/T oil temperature sensor 310 is operating normally.

On the other hand, if it is determined in step S02 that the oil temperature TO is lower than the control oil temperature T_cri, the ECT_ECU 300 determines in step S03 whether the second condition “a” is satisfied. As shown in FIG. 4, the second condition “a” is set to the condition that the elapsed-time “t” is equal to the predetermined time “ta” and the travel distance D is equal to or longer than the predetermined distance Da when the initial oil temperature TO_int is equal to or higher than the predetermined very low temperature T_a. The second condition “a” corresponds to the relationship indicated by the solid line LNa in FIG. 2.

The initial oil temperature TO_int is set based on the temperature of the atmosphere surrounding the vehicle when the engine 100 is started, because the initial oil temperature TO_int is substantially equal to the temperature of the atmosphere surrounding the vehicle when the engine 100 is started. The temperature of the atmosphere surrounding the vehicle when the engine 100 is started is detected based on the coolant temperature TW and the intake-temperature TA detected by the engine coolant temperature sensor 304 and the engine intake-temperature sensor 306, respectively, when the engine 100 is started. Namely, it is determined that the initial oil temperature TO_int is equal to or higher than the predetermined very low temperature T_a, if each of the coolant temperature TW and the intake-temperature TA is equal to or higher than the predetermined very low temperature T_a. When the initial oil temperature TO_int is set, the initial oil temperature TO_int may be determined based on one of the coolant temperature TW and the intake-temperature TA when the engine 100 is started.

If it is determined in step S03 that the second condition “a” is satisfied, the ECT_ECU 300 determines in step S09 that a failure has occurred in the A/T oil temperature sensor 310. Namely, as shown in FIG. 2, the ECT_ECU 300 determines that a failure has occurred in the A/T oil temperature sensor 310 if the oil temperature TO, which is detected by the A/T oil temperature sensor 310 when the elapsed-time “t” reaches the predetermined time “ta”, is lower than the control start oil temperature T_cri in the case where the initial oil temperature TO_int is equal to or higher than the predetermined very low temperature T_a.

On the other hand, if it is determined in step S03 that the second condition “a” is not satisfied, the ECT_ECU 300 determines in step S04 whether the second condition “b” is satisfied. As shown in FIG. 4, the second condition “b” is set to the condition that the elapsed-time “t” is equal to the predetermined time “tb” (“tb”>“ta”) and the travel distance D is equal to or longer than the predetermined distance Db (Db>Da) when the initial oil temperature TO_int is equal to or higher than the predetermined temperature T_b that is lower than the predetermined very low temperature T_a. As described above, the initial oil temperature TO_int is set based on the result of detection of the coolant temperature TW and the intake-temperature TA. Namely, when the second condition “a” is not satisfied, the ECT_ECU 300 determines whether a failure has occurred in the A/T oil temperature sensor 310 when the longer elapsed-time “t” has elapsed since the engine 100 is started, on the assumption that the initial oil temperature TO_int is lower than the predetermined very low temperature T_a.

If it is determined in step S04 that the second condition “b” is satisfied, the ECT_ECU 300 determines in step S09 that a failure has occurred in the A/T oil temperature sensor 310. Namely, the ECT_ECU 300 determines that a failure has occurred in the A/T oil temperature sensor 310, if the oil temperature TO detected by the A/T oil temperature sensor 310 is still lower than the control start oil temperature T_cri even when the elapsed-time “tb”, which is longer than the predetermined time “ta” has elapsed since the engine 100 is started.

On the other hand, if it is determined in step S04 that the second condition “b” is not satisfied, the ECT_ECU 300 determines in step S05 whether the second condition “c” is satisfied. As shown in FIG. 4, in the second condition “c”, each of the elapsed-time “t” and the travel distance D is set to a value greater than that in the second condition “b”. Namely, when the second condition “b” is not satisfied, the ECT_ECU 300 determines whether a failure has occurred in the A/T oil temperature sensor 310 when the elapsed-time “t”, which is longer than the predetermined time “tb”, has elapsed since the engine 100 is started.

If it is determined in step S05 that the second condition “c” is satisfied, the ECT_ECU 300 determines in step S09 that a failure has occurred in the A/T oil temperature sensor 310. On the other hand, if it is determined that the second condition “c” is not satisfied, the ECT_ECU 300 determines that the desired oil temperature TO has not been reached even after the sufficiently long elapsed-time “t” has elapsed since the engine 100 is started, due to a failure in a component other than the A/T oil temperature sensor 310. Therefore, the ECT_ECU 300 does not determine whether a failure has occurred in the A/T oil temperature sensor 310.

If it is determined in step S06 that the oil temperature TO detected by the A/T oil temperature sensor 310 is equal to or higher than the control ensured oil temperature T_max, the ECT_ECU 300 determines in step S08 whether the second condition “d” is satisfied. As shown in FIG. 4, the second condition “d” at this time is set to the condition that the coolant temperature TW, which is detected when the engine 100 is started, is lower than the predetermined temperature T1, and the coolant temperature TW, which is detected when the predetermined elapsed-time “t” has elapsed since the engine 100 is started, is equal to or higher than the predetermined temperature T2. The predetermined temperature T1 corresponds to the coolant temperature TW that is detected when the engine 100 is started while the engine 100 is operating normally. The predetermined temperature T2 corresponds to the coolant temperature TW that is detected when the predetermined elapsed-time “t” has elapsed since the engine 100 is started while the engine 100 is operating normally. Namely, the second condition “d” corresponds to the condition used for determining whether the engine 100 is operating normally.

If it is determined in step S08 that the second condition “d” is satisfied, namely, if it is determined that the detected oil temperature TO is high although the engine 100 is operating normally, the ECT_ECU 300 determines in step S09 that a failure has occurred in the A/T oil temperature sensor 310.

On the other hand, if it is determined that the second condition “d” is not satisfied, namely, it is determined that the engine 100 is not operating normally, the ECT_ECU 300 does not determine whether a failure has occurred in the A/T oil temperature sensor 310.

As described so far, if the oil temperature TO, which is detected by the A/T oil temperature sensor 310 when one of the second conditions (a) to (d) is satisfied, is lower than the control start oil temperature T_cri or is equal to or higher than the control ensured oil temperature T_max, the ECT_ECU 300 determines that a failure has occurred in the A/T oil temperature sensor 310. Then, the ECT_ECU 300 determines in step S10 whether this determination result is obtained in the routine performed for the first time.

If the determination that a failure has occurred in the A/T oil temperature sensor 310 is made in the routine performed for the second time or thereafter, the ECT_ECU 300 finally determines that a failure has occurred in the A/T oil temperature sensor 310. The ECT_ECU 300 turns on a warning light to notify the user of the failure in step S11. The ECT_ECU 300 also displays a failure code indicating that a failure has occurred in the A/T oil temperature sensor 310 on display means 400 in step S12.

As described above, with the detection device for an A/T oil temperature sensor in the related art, whether a failure has occurred in the A/T oil temperature sensor 310 is determined at or after the time point at which the elapsed-time “t” reaches the predetermined time “ta” corresponding to the second condition “a”. The predetermined time “ta” is set to the elapsed-time “t” that is required for the oil temperature TO to increase to the control start oil temperature T_cri when the initial oil temperature TO_int is the predetermined very low temperature T_a. Therefore, according to the failure detection method for the A/T oil temperature sensor 310 in the related art, it takes long until the failure determination is started. Accordingly, when the elapsed-time “t” is relatively short, whether a failure has occurred in the A/T oil temperature sensor 310 cannot be determined. As a result, it becomes difficult to sufficiently frequently determine whether a failure had occurred in the A/T oil temperature 310.

In contrast to this, in the failure detection method for the A/T oil temperature sensor according to the invention, as will be described below, the elapsed-time “t” that is required until the failure determination is started is variable based on the initial oil temperature TO_int. Accordingly, when the initial oil temperature TO_int is relatively high, whether a failure has occurred in the A/T oil temperature sensor is determined when the elapsed-time “t”, which is shorter than the predetermined time “ta” in the related art, has elapsed since the engine 100 is started.

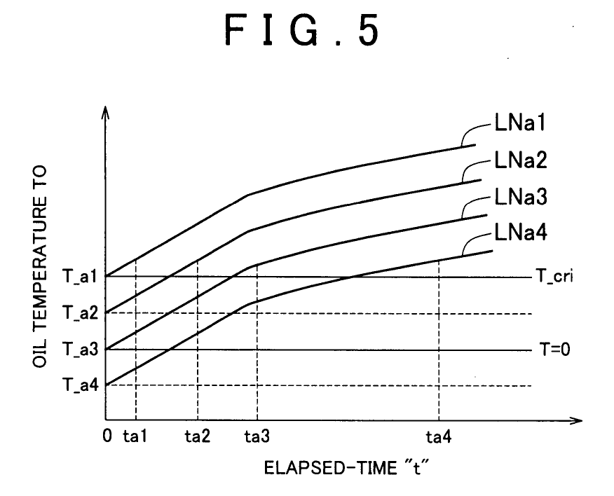

Next, the failure detection method for the A/T oil temperature sensor according to the embodiment of the invention will be described. FIG. 5 illustrates the graph showing the relationship between the oil temperature TO detected by the A/T oil temperature sensor 310 and the elapsed-time “t” that is elapsed since the engine 100 is stated, which is used in the embodiment of the invention.

The solid line LNa4 in FIG. 5 corresponds to the relationship between the oil temperature TO detected by the A/T oil temperature sensor that is operating normally and the elapsed-time “t” that has elapsed since the engine 100 is started, which is indicated by the solid line LNa in FIG. 2. Namely, the oil temperature TO increases with an increase in the elapsed-time “t”, from the predetermined very low temperature T_a4 (T_a4=T_a) corresponding to the initial oil temperature TO_int. The oil temperature TO exceeds the control start oil temperature T_cri when the elapsed-time “t” reaches the predetermined time ta4 (ta4=ta).

In the embodiment, several relationships between the oil temperature TO and the elapsed-time “t”, which vary in the initial oil temperature TO_int, are virtually set based on the relationship that is obtained when the initial oil temperature TO_int is the very low temperature T_a4. For example, in FIG. 5, as the initial oil temperature TO_int, four oil temperatures T_a1 to T_a4 are set. The minimum value among these four oil temperatures is T_a4 that is the predetermined very low temperature T_a. The maximum value among these four oil temperatures is T_a1 that is the control start oil temperature T_cri. These four oil temperatures increases from T_a4 to T_a1 in incremental steps. Then, the four relationships indicated by the solid lines LNa1 to LNa4 are set using the oil temperatures T_a1 to T_a4 as the initial oil temperature TO_int, respectively. In the embodiment, the four relationships between the oil temperature TO and the elapsed-time “t” are set. However, the number of the relationships to be set is not particularly limited.

More specifically, the relationship indicated by the solid line LNa1 is set so as to be substantially parallel to the relationship indicated by the solid line LN4, using the oil temperature T_a1 (corresponding to the control start oil temperature T_cri) as the initial oil temperature TO_int. The relationship indicated by the solid line LNa2 is set so as to be substantially parallel to the relationship indicated by the solid line LNa4, using the temperature T_a2, which is lower than the control start oil temperature T_cri, as the initial oil temperature TO_int. The relationship indicated by the solid line LNa3 is set so as to be substantially parallel to the relationship indicated by the solid line LNa4, using the oil temperature T_a3, which is lower than the oil temperature T_a2, as the initial oil temperature TO_int.

The elapsed-time “t” that is required for the oil temperature TO to exceed the control start oil temperature T_cri is obtained for each of the relationships indicated by the solid lines LNa1 to LNa4. As shown in FIG. 5, the elapsed-time ta1, which is required for the oil temperature TO to exceed the control start oil temperature T_cri when the initial oil temperature T_int is T_a1, is the shortest among the four elapsed-times ta1 to ta4. The elapsed-time ta4, which is required for the oil temperature TO to exceed the control start oil temperature T_cri when the initial oil temperature T_int is T_a4, is the longest among the four elapsed-times ta1 to ta4. Namely, as the initial oil temperature T_int increases from T_a4 to T_a1, the elapsed-time “t” gradually decreases from ta4 to ta1.

In the embodiment of the invention, the elapsed-time “t” when the failure determination is made is variable based on the initial oil temperature TO_int, according to the relationships set in FIG. 5. Namely, the elapsed-time “t” is set to decrease as the initial oil temperature TO_int increases. In the example shown in FIG. 5, the elapsed-time “t” when the failure determination is made is set to gradually increase from ta1 to ta4 as the initial oil temperature TO_int decreases from T_a1 to T_a4.

Accordingly, when the initial oil temperature TO_int is sufficiently higher than the predetermined very low temperature T_a, the failure determination is made after a lapse of the elapsed-time “t” that is considerably shorter than the predetermined time “ta”. As a result, the failure determination can be made even when a short time has elapsed since the engine of the vehicle is started, and the failure detection can be made more frequently.

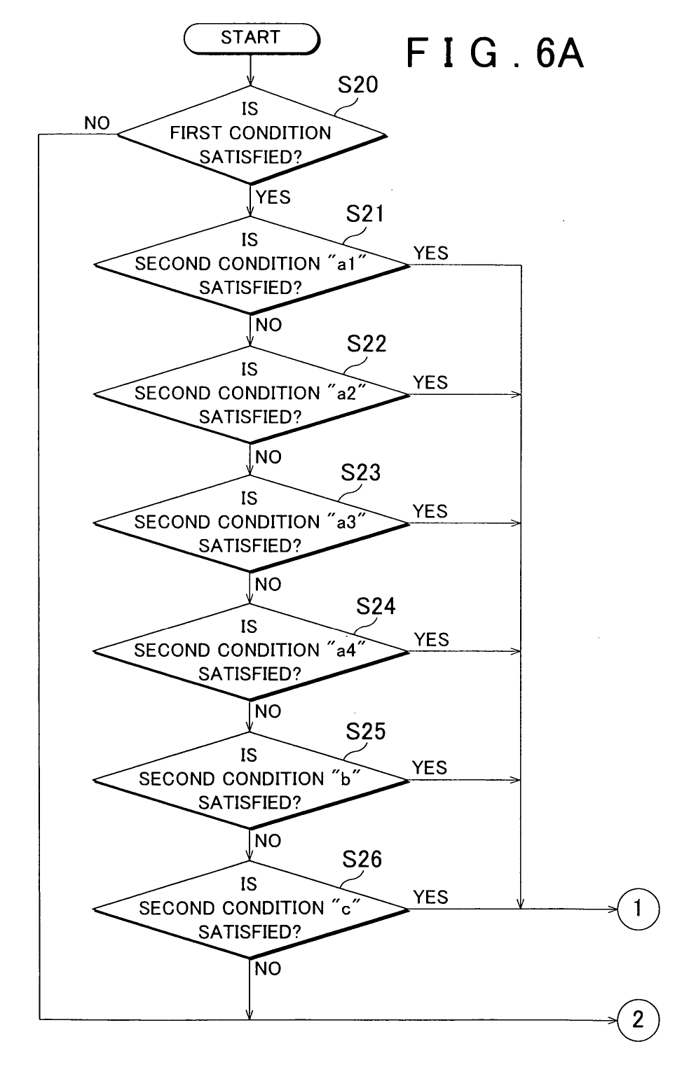

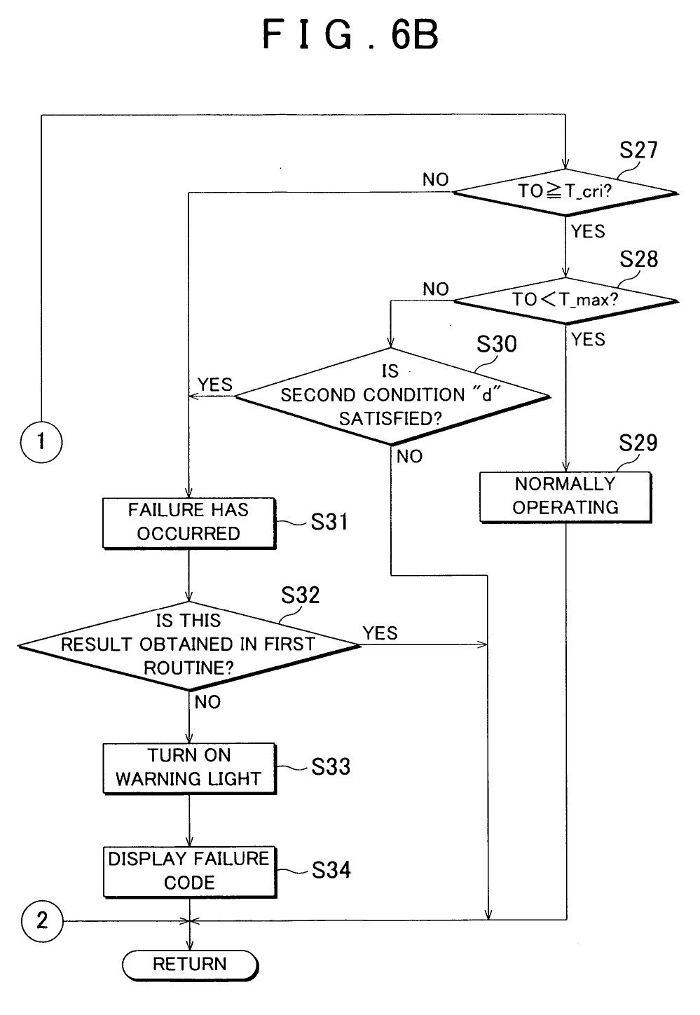

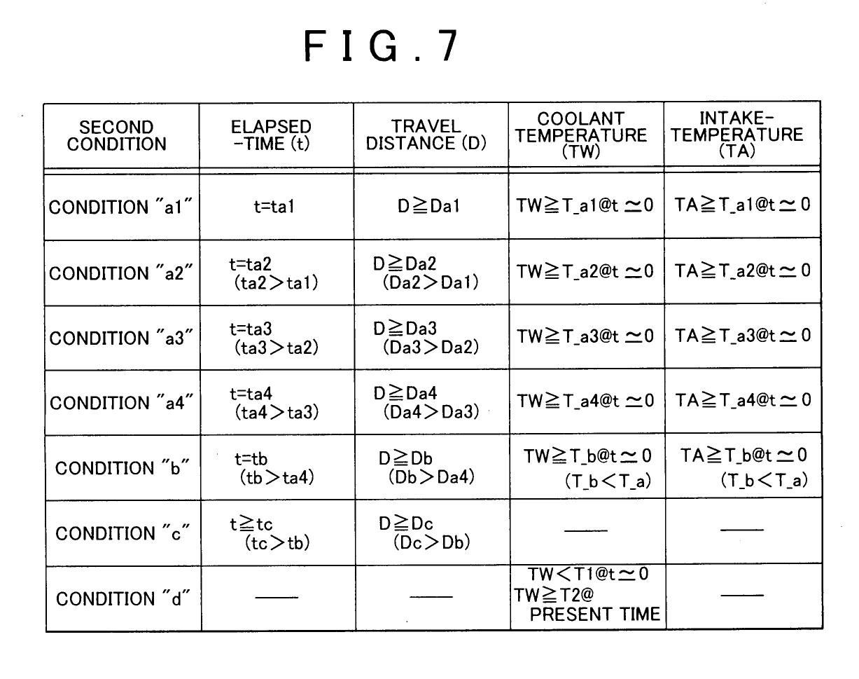

FIG. 6 illustrates the flowchart for describing the failure detection operation performed by the detection device for an A/T oil temperature sensor according to the embodiment of the invention. FIG. 7 illustrates the details of the determination conditions used in the flowchart in FIG. 6.

As shown in FIG. 6, the ECT_ECU 300 first determines in step S20 whether the first condition for the failure detection operation is satisfied. If the first condition is satisfied, the failure detection operation described below can be performed. The first condition includes the condition that there is no electric failure in each of the engine coolant temperature sensor 304, the engine intake-temperature sensor 306, the electronic throttle system, and the like. Unlike the above-mentioned failure detection method in the related art, the first condition does not include the condition that the predetermined elapsed-time “t” has elapsed since the engine 100 is started.

If it is determined that the first condition is satisfied, the ECT_ECU 300 determines in step S21 whether the second condition “a1” is satisfied. As shown in FIG. 7, the second condition “a1” is set to the condition that the elapsed-time “t” is equal to the predetermined time “ta1” and the travel distance D is equal to or longer than the predetermined distance Da1, when the initial oil temperature TO_int is equal to or higher than the very low temperature T_a1. The second condition “a1” corresponds to the relationship indicated by the solid line LNa1 in FIG. 5.

The initial oil temperature TO_int is set based on the temperature of the atmosphere surrounding the vehicle when the engine is started, as in the failure detection method in the related art. The temperature of the atmosphere surrounding the vehicle at this time is detected based on the coolant temperature TW detected by the engine coolant temperature sensor 304 and the intake-temperature TA detected by the engine intake-temperature sensor 306. Namely, it is determined that the initial oil temperature TO_int is equal to or higher than the predetermined very low temperature T_a, if each of the coolant temperature TW and the intake-temperature TA, which are detected when the engine is started, is equal to or higher than the predetermined very low temperature T_a1.

If it is determined that the second condition “a1” is satisfied, the ECT_ECU 300 determines in step S27 whether the oil temperature TO detected at this time by the A/T oil temperature sensor 310 is equal to or higher than the control start oil temperature T_cri.

If it is determined in step S27 that the oil temperature TO is equal to or higher than the control start oil temperature T_cri, the ECT_ECU 300 determines in step S28 whether the oil temperature TO is lower than the control ensured oil temperature T_max. If it is determined that the oil temperature TO is lower than the control ensured oil temperature T_max, namely, if it is determined that the oil temperature TO is within the predetermined temperature range (T_cri≦TO<T_max), the ECT_ECU 300 determines in step S29 that the A/T oil temperature sensor 310 is operating normally.

On the other hand, if it is determined in step S27 that the oil temperature TO is lower than the control start oil temperature T_cri, the ECT_ECU 300 determines in step S31 that a failure has occurred in the A/T oil temperature sensor 310.

If it is determined in step S28 that the oil temperature TO is equal to or higher than the control ensured oil temperature T_max, the ECT_ECU 300 determines in step S30 whether the second condition “d” is satisfied. As shown in FIG. 7, the second condition “d” at this time is set to the condition that the coolant temperature TW, which is detected when the engine is started, is lower than the predetermined temperature T1 and the coolant temperature TW, which is detected when the predetermined elapsed-time has elapsed since the engine is started, is equal to or higher than the predetermined temperature T2. The second condition “d” is the same as the second condition “d” in FIG. 4, and corresponds to the condition for determining whether the engine 100 is operating normally.

If it is determined in step S30 that the second condition “d” is satisfied, namely, if it is determined that the detected oil temperature TO is high although the engine 100 is operating normally, the ECT_ECU 300 determines in step S31 that a failure has occurred in the A/T oil temperature sensor 310.

On the other hand, if it is determined in step S30 that the second condition “d” is not satisfied, namely, if it is determined that the engine. 100 is not operating normally, the ECT_ECU 300 does not determine whether a failure has occurred in the A/T oil temperature sensor 310.

If it is determined in step S21 that the second condition “a1” is not satisfied, the ECT_ECU 300 determines in step S22 whether the second condition “a2” is satisfied. As shown in FIG. 7, the second condition a2 is set to the condition that the elapsed-time “t” is equal to the predetermined time “ta2” and the travel distance D is equal to or longer than the predetermined distance Da2 when the initial oil temperature TO_int is equal to or higher than the predetermined oil temperature T_a2. The second condition “a2” corresponds to the relationship indicated by the solid line LNa2 in FIG. 5.

If it is determined in step S22 that the second condition “a2” is satisfied, the ECT_ECU 300 determines whether a failure has occurred in the A/T oil temperature sensor 310 according to the above-mentioned steps S27 to S31. On the other hand, if it is determined in step S22 that the second condition “a2” is not satisfied, the ECT_ECU 300 determines in step S23 whether the second condition “a3” is satisfied. As shown in FIG. 7, the second condition “a3” is set to the condition that the elapsed-time “t” is equal to the predetermined time “ta3” and the travel distance D is equal to or longer than the predetermined distance Da3 when the initial oil temperature TO_int is equal to or higher the predetermined oil temperature T_a3. The second condition “a3” corresponds to the relationship indicated by the solid line LNa3 in FIG. 5.

If it is determined in step S23 that the second condition “a3” is satisfied, the ECT_ECU 300 determines whether a failure has occurred in the A/T oil temperature sensor 310 according to steps S27 to S31. On the other hand, if it is determined in step S23 that the second condition “a3” is not satisfied, the ECT_ECU 300 determines in step S24 whether the second condition “a4” is satisfied. As shown in FIG. 7, the second condition “a4” is set to the condition that the elapsed-time “t” is equal to the predetermined time “ta4” and the travel distance D is equal to or longer than the predetermined distance Da4 when the initial oil temperature TO_int is equal to or higher than the predetermined oil temperature T_a4. The second condition “a4” corresponds to the relationship indicated by the solid line LNa4 in FIG. 5. The second condition “a4” is the same as the second condition “a” in FIG. 4.

If it is determined in step S24 that the second condition “a4” is satisfied, the ECT_ECU 300 determines whether a failure has occurred in the A/T oil temperature sensor 310 according to steps S27 to S31. On the other hand, if it is determined in step S24 that the second condition “a4” is not satisfied, the ECT_ECU 300 determines in step S25 whether the second condition “b” is satisfied.

As shown in FIG. 7, the second condition “b” is set to the condition that the elapsed-time “t” is equal to the predetermined time “tb” (tb>ta) and the travel distance D is equal to or longer than the predetermined distance Db (Db>Da) when the initial oil temperature TO_int is equal to or higher than the predetermined temperature T_b that is lower than the predetermined very low temperature T_a. Namely, if the second condition “a” is not satisfied, the ECT_ECU 300 determines whether a failure has occurred in the A/T oil temperature sensor 310 when the longer elapsed-time “t” has elapsed since the engine 100 is started, on the assumption that the initial oil temperature TO_int is lower than the predetermined very low temperature T_a4.

If it is determined in step S25 that the second condition “b” is satisfied, the ECT_ECU 300 determines whether a failure has occurred in the A/T oil temperature sensor 310, according to steps S27 to S31.

On the other hand, if it is determined in step S25 that the second condition “b” is not satisfied, the ECT_ECU 300 determines in step S26 whether the second condition “c” is satisfied. As shown in FIG. 7, in the second condition “c”, the elapsed-time “t” and the travel distance D are set to the values larger than those in the second condition “b”. Namely, if the second condition “b” is not satisfied, the ECT_ECU 300 determines whether a failure has occurred in the A/T oil temperature sensor 31 when the time longer than the predetermined time “tb” has elapsed since the engine 100 is started.

If it is determined in step S26 that the second condition “c” is satisfied, the ECT_ECU 300 determines whether a failure has occurred in the A/T oil temperature sensor 310, according to steps S27 to S31. On the other hand, if it is determined in step S26 that the second condition “c” is not satisfied, the ECT_ECU 300 determines that the desired oil temperature TO has not been reached even after a lapse of the sufficiently long elapsed-time “t” due to a failure that has occurred in a component other than the A/T oil temperature sensor 310. Accordingly, the ECT_ECU 310 does not determine whether a failure has occurred in the oil temperature sensor 310.

As described above, if the oil temperature TO, which is detected by the A/T oil temperature sensor 310 when one of the second conditions “a1” to “a4” and the second conditions “b” to “d” is satisfied, is lower than the control start oil temperature T_cri or equal to or higher than the control ensured oil temperature T_max, the ECT_ECU 300 determines that a failure has occurred in the A/T oil temperature sensor 310. Then, the ECT_ECU 300 determines in step S32 whether this determination result is obtained in the routine performed for the first time.

If it is determined that a failure has occurred in the A/T oil temperature sensor 310 in the routine performed for the second time or thereafter, the ECT_ECU 300 finally determines that a failure has occurred in the A/T oil temperature sensor 310. The ECT_ECU 300 turns ON the warning light in step S33, and displays a failure code indicating that a failure has occurred in the A/T oil temperature sensor 310 on the display means 400 in step S34.

As described so far, according to the embodiment of the invention, whether a failure has occurred in the A/T oil temperature sensor 31 is determined when a relatively short elapsed-time “t” has elapsed since the engine 100 is started, if the initial oil temperature TO_int is relatively high. Accordingly, as compared with the failure detection method in the related art, in which the failure determination is uniformly made when a long elapsed-time “t” has elapsed since the engine 100 is started, the failure determination can be made even when a short elapsed-time has elapsed since the engine 100 is started. As a result, a failure determination can be made more frequently than in the related art.

The embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

The invention can be applied to a detection device for an oil temperature sensor for an automatic transmission, and a vehicle including the detection device.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A failure detection device for an oil temperature sensor that detects an oil temperature of hydraulic fluid of an automatic transmission mounted in a vehicle, comprising:
a determining device that determines that a failure has occurred in the oil temperature sensor if the oil temperature, which is detected by the oil temperature sensor when a predetermined elapsed-time has elapsed since an engine of the vehicle is started, is not within a predetermined temperature range, wherein
the determining device variably sets the predetermined elapsed-time based on the oil temperature that is obtained when the engine of the vehicle is started.

2. The failure detection device for an oil temperature sensor according to claim 1, wherein
the determining device sets the predetermined elapsed-time to a lower value as the oil temperature that is obtained when the engine is started is higher.

3. The failure detection device for an oil temperature sensor according to claim 2, wherein
the determining device decides the oil temperature when the engine is started, based on a temperature of an atmosphere surrounding the vehicle.

4. The failure detection device for an oil temperature sensor according to claim 3, further comprising:
a coolant temperature sensor that detects a coolant temperature of a coolant for the engine; and
an intake-temperature sensor that detects an intake-temperature of air taken in the engine, wherein
the determining device detects the temperature of the atmosphere surrounding the vehicle based on at least one of the coolant temperature and the intake-temperature that are obtained when the engine is started.

5. The failure detection device for an oil temperature sensor according to claim 1, wherein
the predetermined temperature range is a range of the oil temperature at which a shift operation of the automatic transmission can be performed normally.

6. The failure detection device for an oil temperature sensor according to claim 5, wherein
an upper limit of the predetermined elapsed-time is the elapsed-time that is required for the oil temperature to reach a lower limit of the predetermined temperature range, if the oil temperature obtained when the engine is started is equal to a lower limit of a range of the oil temperature that the oil temperature should reliably detect.

7. A failure detection method for an oil temperature sensor that detects an oil temperature of hydraulic fluid of an automatic transmission mounted in a vehicle, comprising:
determining that a failure has occurred in the oil temperature sensor, if the oil temperature, which is detected by the oil temperature sensor when a predetermined elapsed-time has elapsed since an engine of the vehicle is started, is not within a predetermined temperature range, wherein
the predetermined elapsed-time is variably set based on the oil temperature that is obtained when the engine of the vehicle is started.

8. The failure detection method for an oil temperature sensor according to claim 7, wherein
the predetermined elapsed-time is set to a lower value as the oil temperature that is obtained when the engine is started is higher.

9. The failure detection method for an oil temperature sensor according to claim 8, wherein
the oil temperature when the engine is started is decided based on a temperature of an atmosphere surrounding the vehicle.

10. The failure detection method for an oil temperature sensor according to claim 9, further comprising:
detecting a coolant temperature of a coolant for the engine; and
detecting an intake-temperature of air taken in the engine, and
detecting the temperature of the atmosphere surrounding the vehicle based on at least one of the coolant temperature and the intake-temperature that are obtained when the engine is started.

11. The failure detection method for an oil temperature sensor according to claim 7, wherein
the predetermined temperature range is a range of the oil temperature at which a shift operation of the automatic transmission can be performed normally.

12. The failure detection method for an oil temperature sensor according to claim 11, wherein
an upper limit of the predetermined elapsed-time is the elapsed-time that is required for the oil temperature to reach a lower limit of the predetermined temperature range, if the oil temperature obtained when the engine is started is equal to a lower limit of a range of the oil temperature that the oil temperature should reliably detect.
